(19) United States
(12) Patent Application Publication
(10) Pub. No.: US 2002/0130559 A1
(43) Pub. Date: Sep. 19, 2002

(54) Power adapter

(75) Inventor: Sheng-Chieh Lin, Taoyuan (TW)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Delta Electronics, Inc.

(21) Appl. No.: 10/099,312

(22) Filed: Mar. 15, 2002

(30) Foreign Application Priority Data
Mar. 16, 2001 (TW) 090204020

(51) Int. Cl. H02M 1/00

(52) U.S. Cl. 307/151

(57) ABSTRACT

The present invention discloses a power adapter for connecting an electric appliance to an AC main power. The power adapter includes an electrical device having at least two metal prongs in the power input/output end thereof, and a connector having at least two recesses for sleeving the metal prongs respectively and electrically connecting the connector to the electrical device. In addition, there is a height difference between the bottoms of the connector and the electrical device. Moreover, each of the two sides of the connector includes a hollow region respectively for the convenience of assembling and disassembling the connector and the electrical device. Furthermore, there are pit-knob matching structures in the connector and the electrical device for fixing the position and preventing unfastening of the connector and the electrical device in the assembling state.

### FIELD OF THE INVENTION

This invention relates to a power adapter, and more particularly to a power adapter for connecting an electric appliance to an AC main power.

### BACKGROUND OF THE INVENTION

With the progress of science and technology, many inventions of present electric appliances increase the convenience of life. Many electric appliances such as portable electric appliances and mobile phones are more and more common in daily life, and these electric appliances have to be power supplied through the AC converting adapters.

Please refer to FIG. 1. FIG. 1 is a schematical view showing the structure of the power adapter according to the prior art including an electrical device (such as a power supply or a charger) 10 and an AC cable 11. The electrical device 10 is connected to a power receptacle by the AC cable 11 to provide the main power for the electrical device 10. However, such way for connecting an electric appliance to an AC main power has the following disadvantages:

1. Inconvenient to carry: It is inconvenient for a user to carry the AC cable when traveling on business or for a vacation. In addition, the plug form of the AC cable is fixed and thereby cannot adapt to different receptacle forms in different countries of the world.

2. Easy to cause danger: People are tripped over the cable easily when using carelessly and therefore the accidents will happen.

Therefore, the present invention provides a portable power adapter for connecting an electric appliance to an AC main power which overcomes the disadvantages described above.

### SUMMARY OF THE INVENTION

It is an object of the present invention to provide a power adapter for using safely and carrying conveniently.

It is another object of the present invention to provide a power adapter with a height difference design for holing and forcing easily and increasing the heat-dissipating efficiency of the electrical device and the connector.

It is an additional object of the present invention to provide a power connector with a hollow region design for the convenience of assembling and disassembling the connector and the electrical device.

In accordance with an aspect of the present invention, the power adapter for connecting an electric appliance to an AC main power includes an electrical device having at least two metal prongs in the power input/output end thereof, and a connector having at least two recesses for sleeving the metal prongs respectively and electrically connecting the connector to the electrical device. In addition, there is a height difference between the bottoms of the connector and the electrical device.

Preferably, the electrical device is a power supply or a charger.

Preferably, the metal prongs are disposed in a cavity of the electrical device, and the recesses are disposed on a protruding portion of the connector.

Preferably, the shapes and sizes of the cavity and the protruding portion are the same for matching and fixing tightly.

Preferably, the connector further includes at least two conducting slices for plugging the power adapter in an exterior AC receptacle.

Preferably, the conducting slice is made of copper.

Preferably, when the conducting slices are plugged in the exterior AC receptacle, a space is formed below the bottom of the electrical device by the height difference, which is beneficial for holding and forcing by a user and increases the heat-dissipating efficiency of the electrical device and the connector.

Preferably, each of the two sides of the connector includes a hollow region respectively for the convenience of assembling and disassembling the connector and the electrical device.

Preferably, the connector further includes at least one pit (or knob) and the electrical device further includes at least one knob (or pit) for fixing the position and preventing unfastening of the connector and the electrical device.

In accordance with another aspect of the present invention, the power adapter for converting an alternating current (AC) includes an electrical device having at least two metal prongs in the power input/output end thereof; and a connector having at least two recesses for sleeving the metal prongs respectively and electrically connecting the connector to the electrical device. In addition, each of the two sides of the connector includes a hollow region respectively for the convenience of assembling and disassembling the connector and the electrical device.

Preferably, the electrical device is a power supply or a charger.

Preferably, the metal prongs are disposed in a cavity of the electrical device, and the recesses are disposed on a protruding portion of the connector.

Preferably, the shapes and sizes of the cavity and the protruding portion are the same for matching and fixing tightly.

Preferably, the connector further includes at least two conducting slices for plugging the power adapter in an exterior AC receptacle.

Preferably, the conducting slice is made of copper.

Preferably, when the conducting slices are plugged in the exterior AC receptacle, a space is formed below the bottom of the electrical device by a height difference between the bottoms of the connector and the electrical device, which is beneficial for holding and forcing by a user and increases the heat-dissipating efficiency of the electrical device and the connector.

Preferably, the connector further includes at least one pit (or knob) and the electrical device further includes at least one knob (or pit) for fixing the position and preventing unfastening of the connector and the electrical device.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematical view showing the structure of the power adapter according to the prior art;

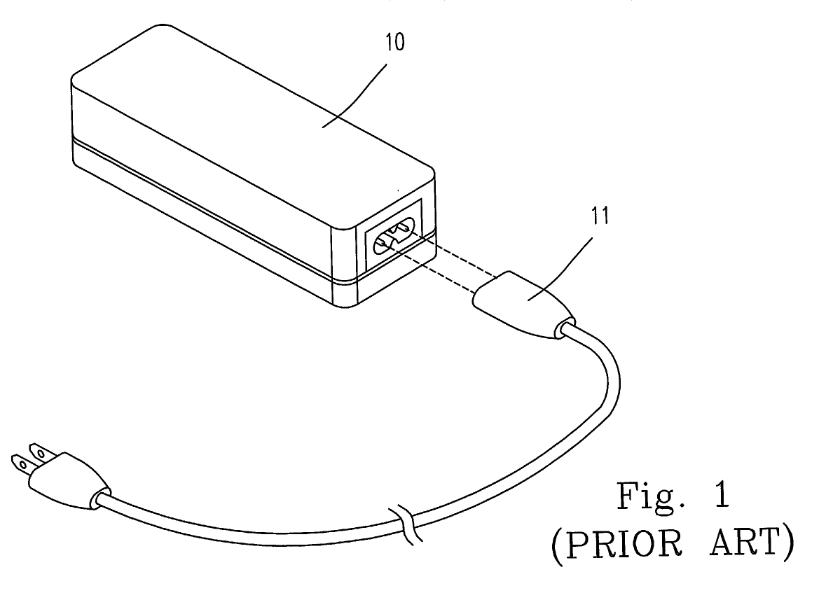

FIG. 2 is a schematical view showing the disassembling structure of the power adapter according to a preferred embodiment of the present invention;

FIG. 3 is a schematical view showing the assembling structure of the power adapter according to a preferred embodiment of the present invention.

FIG. 4 is a bottom plane view showing the structure of the electrical device according to a preferred embodiment of the present invention;

FIG. 5 is a top plane view showing the structure of the connector according to a preferred embodiment of the present invention; and

FIGS. 6 and 7 are schematical views showing the pit-knob matching structures of the power adapter according to a preferred embodiment of the present invention.

### DETAILED DESCRIPTION OF THE PREFERRED EMBODIMENT

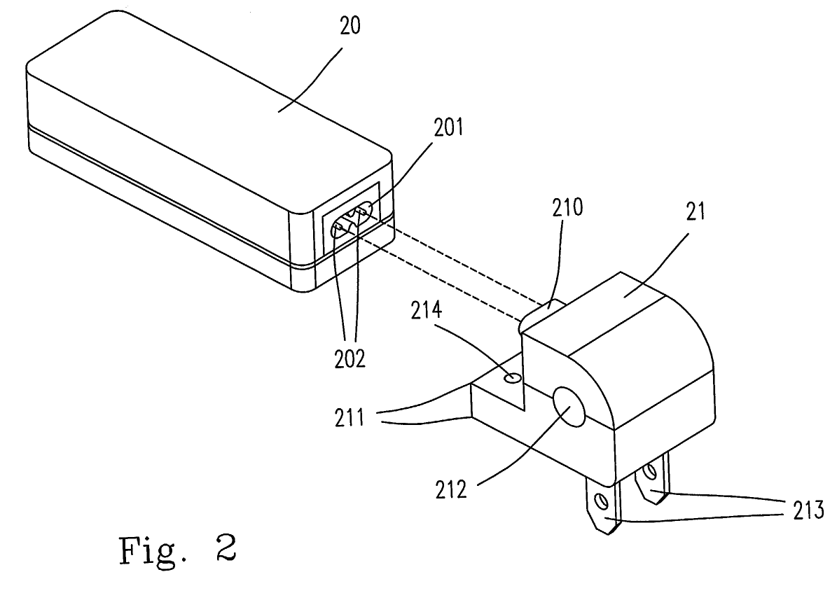

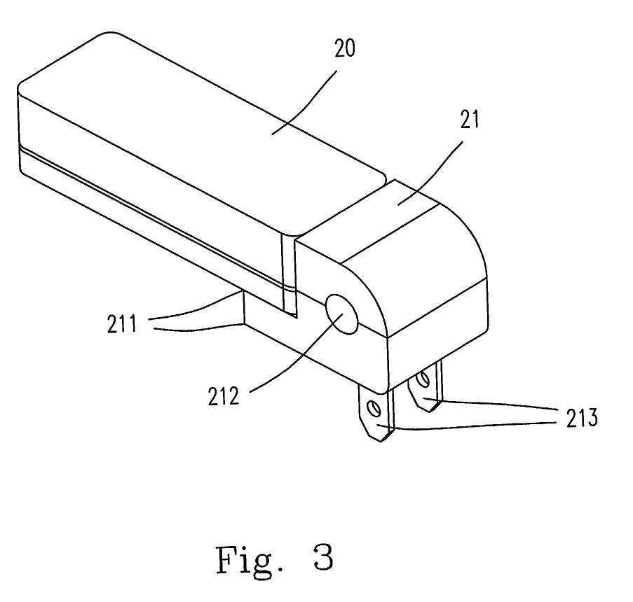

Please refer to FIGS. 2 and 3 showing the structure of the power adapter according to a preferred embodiment of the present invention. A power adapter includes an electrical device 20 and a connector 21 for connecting an electric appliance to an AC main power. The electrical device 20 is a power supply or a charger. The power input/output end of the electrical device 20 has two metal prongs 202 disposed in a cavity 201. Preferably, the two metal prongs are two metal sticks, and the number of the metal prongs can be changed to adjust to the requirements or the standards in different countries.

Please refer to FIG. 2. The connector 21 has two recesses (not shown) disposed on a protruding portion 210. The two recesses can sleeve the two metal prongs 201, such that the connector 21 and the electrical device 20 can be tightly fixed and electrically connected (as shown in FIG. 3) so as to connect the electric appliance to the AC main power. Of course, the shapes and the sizes of the cavity 201 disposing the two metal prongs 202 and the protruding portion 210 of the connector 21 are the same for matching and fixing tightly. In addition, there is a height difference 211 between the bottoms of the connector 21 and the electrical device 20. When the two conducting slices 213 of the power adapter are plugged in an exterior AC receptacle (not shown), a space is formed below the bottom of the electrical device 20 by the height difference, which is beneficial for holding and forcing be a user and increases the heat-dissipating efficiency of the conducting slices 213 of the connector 21 and the electrical device 20. Furthermore, each of the two sides of the connector 21 includes a hollow region 212 respectively for the convenience of assembling and disassembling the connector 21 and the electrical device 20.

Preferably, the conducting slices 213 of the connector 21 are made of copper, and the shapes and the number of the conducting slices 213 can be changed to adjust to different receptacle standards of different countries. In addition, the conducting slices can be designed as a rotatable form which can be folded down for the convenience of carry and storage.

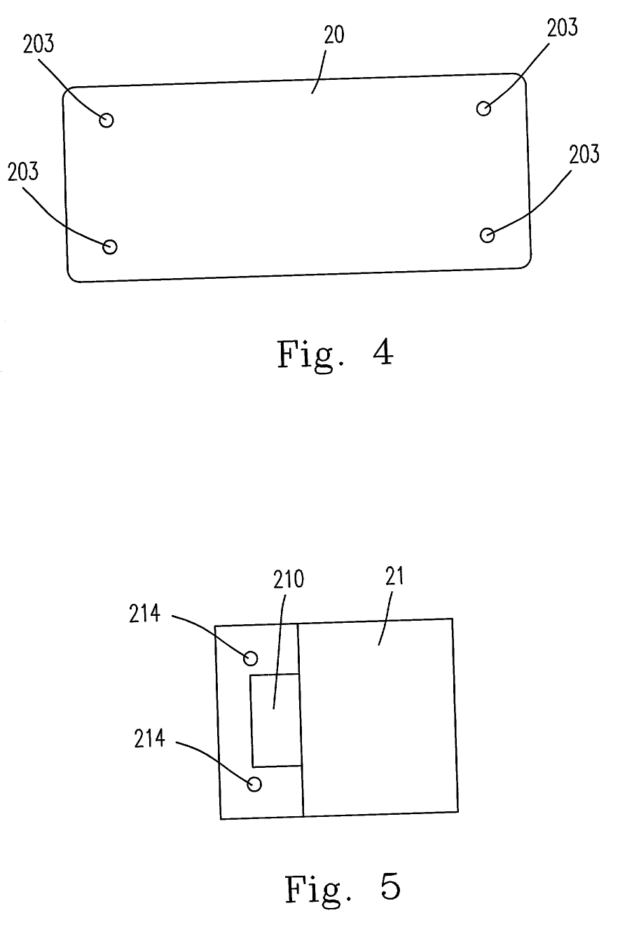

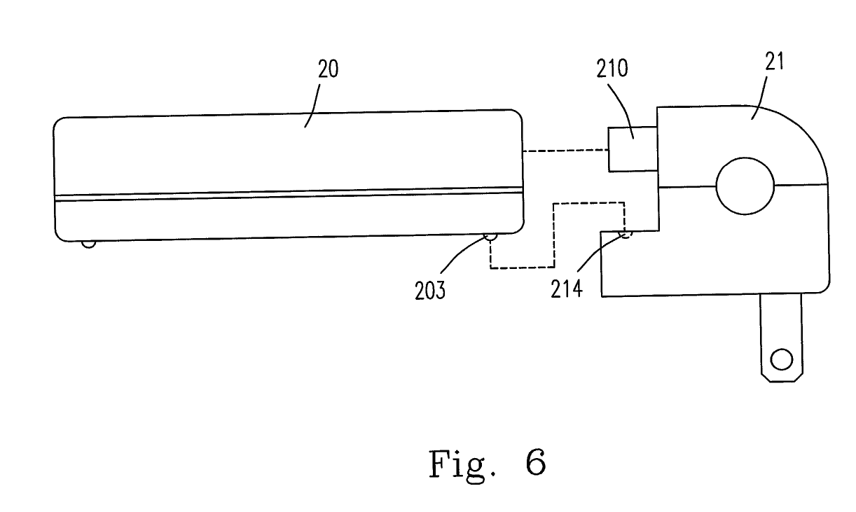

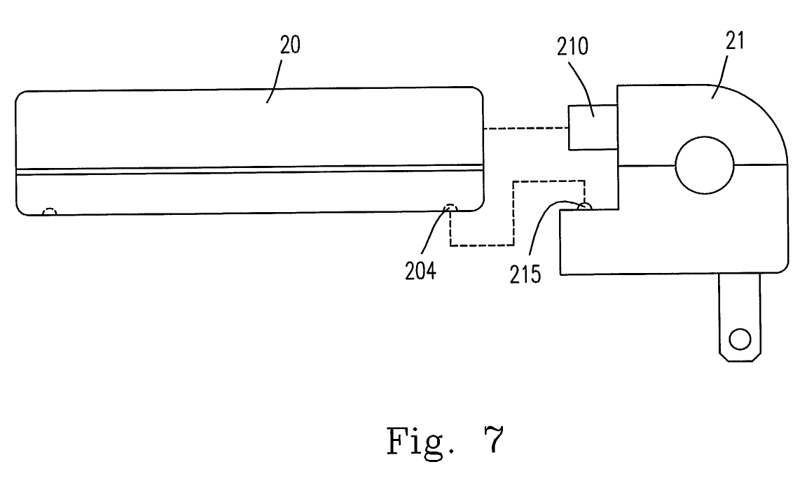

Please refer to FIGS. 4 to 7. Generally, there are four knobs 203 respectively at the four corners of the bottom of the electrical device 20. Accordingly, the connector 21 of the present invention further includes two pits 214 which can match with the two knobs 203 in the connecting end of the electrical device 20 for fixing the position and preventing unfastening of the connector 21 and the electrical device 20 (as shown in FIG. 6) in the assembling state. Of course, such function can be also achieved by matching two pits 204 of the electrical device 20 and two knobs 215 of the connector 21 (as shown in FIG. 7).

In conclusion, the power adapter according to the present invention has the following advantages:

1. With the same shapes and sizes of the cavity and the protruding portion, the electrical device and the connector can be tightly fixed and electrically connected. Thus, the power adapter design of the present invention is simple and practicable.

2. By the height difference between the bottoms of the connector and the electrical device, there is a space below the bottom of the electrical device which is beneficial for holding and forcing by a user and increases the heat-dissipating efficiency of the electrical device and the connector.

3. The connector has two hollow regions on both sides respectively, and is therefore convenient for a user to assemble and disassemble the connector and the electrical device.

4. There are pit-knob matching structures in the connector and the electrical device for fixing the position and preventing unfastening of the connector and the electrical device in the assembling state.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power adapter for connecting an electric appliance to an AC main power, comprising:
an electrical device having at least two metal prongs in the power input/output end thereof; and
a connector having at least two recesses for sleeving said metal prongs respectively and electrically connecting said connector to said electrical device;
wherein there is a height difference between the bottoms of said connector and said electrical device.

2. The power adapter according to claim 1 wherein said electrical device is one of a power supply and a charger.

3. The power adapter according to claim 1 wherein said metal prongs are disposed in a cavity of said electrical device, and said recesses are disposed on a protruding portion of said connector.

4. The power adapter according to claim 3 wherein the shapes and sizes of said cavity and said protruding portion are the same for matching and fixing tightly.

5. The power adapter according to claim 1 wherein said connector further comprises at least two conducting slices for plugging said power adapter in an exterior AC receptacle.

6. The power adapter according to claim 5 wherein said conducting slice is made of copper.

7. The power adapter according to claim 5 wherein when said conducting slices are plugged in said exterior AC receptacle, a space is formed below the bottom of said electrical device by said height difference, which is beneficial for holding and forcing by a user and increases the heat-dissipating efficiency of said electrical device and said connector.

8. The power adapter according to claim 1 wherein each of the two sides of said connector comprises a hollow region respectively for the convenience of assembling and disassembling said connector and said electrical device.

9. The power adapter according to claim 1 wherein said connector further comprises at least one pit and said electrical device further comprises at least one knob for fixing the position and preventing unfastening of said connector and said electrical device.

10. The power adapter according to claim I wherein said connector further comprises at least one knob and said electrical device further comprises at least one pit for fixing the position and preventing unfastening of said connector and said electrical device.

11. A power adapter for connecting an electric appliance to an AC main power, comprising:
an electrical device having at least two metal prongs in the power input/ output end thereof; and
a connector having at least two recesses for sleeving said metal prongs respectively and electrically connecting said connector to said electrical device;
wherein each of the two sides of said connector comprises a hollow region respectively for the convenience of assembling and disassembling said connector and said electrical device.

12. The power adapter according to claim 11 wherein said electrical device is one of a power supply and a charger.

13. The power adapter according to claim 11 wherein said metal prongs are disposed in a cavity of said electrical device, and said recesses are disposed on a protruding portion of said connector.

14. The power adapter according to claim 13 wherein the shapes and sizes of said cavity and said protruding portion are the same for matching and fixing tightly.

15. The power adapter according to claim 11 wherein said connector further comprises at least two conducting slices for plugging said power adapter in an exterior AC receptacle.

16. The power adapter according to claim 15 wherein said conducting slice is made of copper.

17. The power adapter according to claim 15 wherein when said conducting slices are plugged in said exterior AC receptacle, a space is formed below the bottom of said electrical device by a height difference between the bottoms of said connector and said electrical device, which is beneficial for holding and forcing by a user and increases the heat-dissipating efficiency of said electrical device and said connector.

18. The power adapter according to claim 11 wherein said connector further comprises at least one pit and said electrical device further comprises at least one knob for fixing the position and preventing unfastening of said connector and said electrical device.

19. The power adapter according to claim 11 wherein said connector further comprises at least one knob and said electrical device further comprises at least one pit for fixing the position and preventing unfastening of said connector and said electrical device.
